(19) United States
(12) Patent Application Publication
(10) Pub. No.: US 2022/0408749 A1
(43) Pub. Date: Dec. 29, 2022

(54) FAT-CONTAINING PRODUCT

(71) Applicant: Upfield Europe B.V., Rotterdam (NL)

(72) Inventors: Estelle Agnes GAUDIER, Rotterdam (NL); Georg Christian DOL, Rotterdam (NL)

(21) Appl. No.: 17/780,454

(22) PCT Filed: Nov. 26, 2020
(86) PCT No.: PCT/EP2020/025541

§ 371 Date: May 26, 2022

(30) Foreign Application Priority Data
Nov. 26, 2019 (EP) 19211620.0

(51) Int. Cl. A23D 7/005; A23D 7/01; A23D 9/013; A23L 5/10

(52) U.S. Cl. CPC A23D 7/0056; A23D 7/013; A23D 9/013; A23D 7/0053; A23D 7/011; A23L 5/11; A23V 2002/00

(57) ABSTRACT

Edible fat-containing product comprising 30-99 wt. % of a fat phase, wherein the product further comprises 0.01-3 wt. % of a plant-based protein and 0.05-3 wt. % of a sugar, the remainder being an aqueous phase up to 100 wt. %, wherein the weight percentages are based on the total weight of the product, a method for its preparation and the use of sugar in an edible fat-containing product as a browning agent.

### FIELD OF THE INVENTION

The present invention relates to an edible fat-containing product, a method for the preparation of fat-containing product and a use thereof.

### BACKGROUND OF THE INVENTION

Edible fat containing products can be classified in oil-in-water emulsions, water-in-oil emulsions, and full fat products. Edible water-in-oil emulsions comprise a continuous fat phase and a dispersed aqueous phase. Well known examples of edible water-in-oil emulsion are butter and margarine. In edible oil-in-water emulsions, the continuous phase and the dispersed phase are the other way around. The continuous phase is an aqueous phase, and the dispersed phase is a fat phase. Typical examples thereof include mayonnaise and milk. Full fat products are products wherein the continuous fat phase forms the vast majority of the product and the dispersed phase is only a minor part of the product.

Water-in-oil emulsions, oil-in-water emulsions, and full fat products can all be suitable for frying, baking and broiling. For frying, a fat containing product is placed on a hot surface, such as a frying pan, wok, or griddle, heated and melted. Various foods can be fried, such as meat, fish, vegetables, potatoes, nuts, tofu, mushrooms, dough-based foods, etc.

Fat-containing products can also be used as an ingredient in food, prior to preparing the food. Baking and broiling are food preparation methods wherein typically the fat-containing products are mixed with food, or the food is coated with the fat-containing product, prior to baking or broiling. The amount of fat-containing product influences the taste and mouthfeel of the food to a large extend.

Fat-containing products, such as butter, are often incorporated in dough-based food, such as cakes, pastries, pies, quiches, and cookies prior to baking. The amount of butter influences the mouthfeel of the food. A lower amount of butter causes to food to feel dry and a higher amount will result in a waxy and heavy mouthfeel. Fat-containing products can also be used to prepare food for broiling. Usually food is marinated with a marinade containing butter, or another type of fat or oil, prior to broiling.

Liquid oil and fat products generally have a higher content of unsaturated fatty acids, which are beneficial for human health. Moreover, using a pourable water-in-oil emulsion instead of a pourable oil further has the advantage that water is introduced during frying, baking or broiling, and therefore the overall amount of oil used for preparing food is lowered, which again has a beneficial health effect. In addition, pourable emulsions tend to spatter less than then liquid plant-based oils.

Fat containing products typically contain a fat or oil phase, and an aqueous phase. When the product is heated together with the food, Maillard reactions occur and the food browns due to chemical reactions between amino acids and sugars. In addition, pleasant flavours develop in the food.

Plant-based fats and oils are preferred for in fat-containing products, as they contain a lower amount of saturated fatty acids, which are known to have a negative effect on health. In addition, there is a large demand from the market for vegan fat-containing products to fry, bake, and broil vegetables and other non-animal derived foods. Plant-based fats and oils are also more sustainable, as the energy requirements for cultivating plants are significantly lower than the energy requirements for raising livestock. However, the use of plant-based fats and oils in water-in-oil emulsions, oil-in-water emulsions, and full fat products has several negative effects as well. One of the major negative effects is that the browning effect achieved with these plant-based products is not as strong the browning effect that butter has on foods prepared by frying, baking or broiling. When food products contain vegetable-based fat and no animal-based fat, the browning and flavour development of these foods is reduced and the resulting food looks less appealing and is less tasty. The lack of browning and flavour development also occurs when meat, fish or vegetables are fried, baked, or broiled using fat-containing products wherein the fat phase only contains plant-based oils and fats.

NL9300536 describes the use of carob seed proteins in combination with sugar as a dairy protein replacement. The products described are high fat spreads (margarine), whereas current day demand is also for low fat (<60 wt %) and liquid products. The carob protein is dispersed in oil prior to the emulsification process, which may lead to unwanted clumping of protein during processing. US 2019/0174786 A1 discloses compositions for inducing a color to a foodstuff, such as a previously baked bread or other starches and proteins. In some embodiments the compositions are browning butters and can include dextrose. US 2008/0181990 A1 discloses food compositions and edible emulsions including a wheat protein isolate or a whole bean powder, and edible oil, and water, further comprising a sweetener such as corn syrup. U.S. Pat. No. 5,958,498 discloses a mayonnaise-like emulsion composition which comprises components of an edible oil, sugar, salt, water and an acidifying agent and a first emulsifier and second emulsifier. The first emulsifier can be vegetable proteins.

### SUMMARY OF THE INVENTION

It is an object of the present invention to provide an edible fat-containing product that provides for effective browning and flavour development, when the food is prepared by frying, baking, or broiling, while still maintaining the beneficial health effects and beneficial environmental effects that are associated with plant-based oils and fats.

It is a further object of the invention to provide an edible fat-containing product that provides for effective browning and flavour development in a high fat (wrapper), high and low fat spread and a liquid or pourable composition.

Surprisingly, it was found that by adding small amounts of plant based protein and a sugar to a product containing plant-based oil or fat, a product is obtained that browns food much more effectively in comparison to the plant-based oil or fat without these proteins and sugars. In addition, desirable flavors develop in the food, during baking, frying, or broiling, resulting in food that is not only visually more attractive, but tastes better as well. Additionally surprising was the observation that the browning effect of the product of the invention was largely independent of carbohydrate and protein levels in the food product that was prepared, thus providing a product with a general applicability. This was the most pronounced in a baking application of the products of the invention.

In a first aspect, the present invention provides an edible fat-containing product comprising a fat phase up to 99 wt. %, the remainder being an aqueous phase up to 100 wt. %, wherein the product further comprises 0.01-3 wt. % of a plant-based protein, preferably plant-based isolate or -concentrate, and 0.05-3 wt. % of a sugar, wherein the weight percentages are based on the total weight of the product.

In a second aspect, the invention relates to a method for the preparation of an edible fat-containing product comprising the steps of:
providing an aqueous component;
providing a plant protein component, preferably a plant protein isolate or -concentrate;
providing a sugar component;
providing a fat phase;
mixing the aqueous component with the plant protein component and the sugar component to provide an aqueous phase; and
mixing the fat phase with the aqueous phase to obtain the edible fat-containing product.

In a third aspect, the invention relates to a use of a sugar in an edible fat-containing product as a browning agent in frying, baking or broiling.

### DETAILED DESCRIPTION OF THE INVENTION

“Fat-containing product” is herein understood as a product containing a fat and/or oil. The terms “fat” and “oil” are used interchangeably. In general a “fat” is solid at standard ambient temperature and pressure and an oil is liquid under these conditions.

An “aqueous phase” is water and optionally any compounds that dissolve in water. Whereas a “fat phase” encompasses any edible oil or fat and optionally any compounds that dissolve in oil or fat.

“Plant-based proteins” are proteins obtained from plants, either directly, or indirectly from a plant extract or dry plant powder, for example. The plant proteins can be obtained specific parts of a plant, such as fruits, seeds, leaves, stems, roots, flowers, etc.

A “sugar” is a soluble carbohydrate which can have a sweet taste.

The edible fat-containing product according to the invention comprises 30-99 wt. % of a fat phase, the remainder of the product is an aqueous phase up to 100 wt. %, 0.01-3 wt. % of a plant-based protein, preferably plant-based isolate or -concentrate, and 0.05-3 wt. % of a sugar, wherein the weight percentages are based on the total weight of the product. When this edible fat-containing product is used for frying food, such as chicken filets, the filet browns to a color that is very similar to the color obtained when frying in butter. The gravy obtained from frying the filet is similar to butter-based gravy in both color and taste. When the weight percentage of plant-based protein is well over 3 percent of the total weight of the product, undesirable thick brown particles may form in the gravy, also depending on the protein level in the used product. The formation of these particles, or sediment is not appreciated by consumers. This formation is due to an unfavorable sugar/plant-based protein ratio which leads to uncontrolled browning through maillard reactions. Preferably, the plant-based protein is a plant-based isolate or plant-based concentrate. A plant-based isolate or a plant-based concentrate has the advantage that it contains a small amount of components that may have a negative effect on the organoleptic properties of the edible fat-containing product. In particular, the incorporation of such an isolate or concentrate may impart less of a plant-like taste (bean-like or acrid taste) to the fat-containing product in comparison to non-isolates or non-concentrates.

An amount of 0.05% of sugar based on the total weight of the product according to the invention is already sufficient to obtain a browning effect and corresponding flavor enhancement of food. The sugar can be one sugar, or a combination of multiple different sugars. It is preferred that relative low amounts of sugar are used. A too high sugar content may result in a sweet taste which is not always desired for a product such as for instance fried chicken. It may be a desirable side effect for instance when used in baking. Typically, for instance in an application an amount of more than 3 wt. % of sugar is less preferred. High sugar contents may lead to the food becoming excessively sweet, and as a consequence, the flavor may become masked.

The plant-based protein and/or the sugar in the edible fat-containing product may be dispersed in the aqueous phase. Dispersing the plant-based protein in the aqueous phase prior to mixing with the fat phase prevents the formation of clumps of plant proteins. This in turn may aid in an enhanced browning effect of foods prepared with the fat-containing product.

The edible fat-containing product may contain an emulsifier. This emulsifier may be a natural emulsifier. Emulsifiers may be incorporated in edible fat-containing products, such as margarines, because of their emulsifying properties. A natural emulsifier is not a non-natural emulsifier. Mono- and diglycerides that are manufactured by the chemical reaction of glycerin with fatty acids or the reaction of glycerin with triglycerides are examples of non-natural emulsifiers. An example of a natural emulsifier is lecithin.

The edible fat-containing product preferably contains lecithin. Lecithin is preferably a plant based lecithin, preferably derived from soy or sunflower, with a preference for sunflower. Lecithin is a natural emulsifier that is economically favorable, and suitable for a vegan product.

All or at least a part of the fat phase of the edible fat-containing product may be enzymatically interesterified. Interesterification is the rearrangement of fatty acid on their glycerol backbone. This rearrangement of fatty acids on triglycerides in oils and fats may change their melting points and slow rancidification. Interesterification is thus advantageous for the edible fat-containing product, as the shelf life and the hardness may increase. Enzymes such as lipases can be used for interesterification. Enzymes have a natural appeal, and as such, the resulting interesterified product appears natural to consumers.

The edible fat-containing product may be an oil-in-water emulsion comprising 50-90 wt. % of a fat phase. The relatively low amount of fat phase is suited for food preparation purposes, where low amounts of fats are desired. These products would be suited to reduce weight gain, especially when the saturated fatty acid content in the fat phase is relatively low. Preferably, this is a pourable or liquid formulation.

The edible fat-containing product may be a water-in-oil emulsion as well, comprising 40-95 wt. % of a fat phase. Preferably, this is spread and may be a high fat spread or a low fat spread.

Margarine is a typical example of a water-in-oil emulsion. Three types of margarines can be distinguished: hard or stick margarine, the so-called wrappers, spreads, and pourable margarines. Spreads are generally sold in tubs and are suitable as butter replacements. They can for example be mixed with dough to provide various foods that can be baked, such as cakes, pastries, pies, quiches, and cookies. An improved taste and browning of the baked foods results from the combination of sugars and plant-based proteins in the product.

The edible fat-containing product may be a full fat product comprising 95-99 wt. % of the fat phase. Full fat products are especially suited for frying, due to their high fat content. Fish, meat, and vegetables can be fried with this full fat product and this food will have a color, taste and mouthfeel very similar to the same food fried in butter.

### Fats and Oils

The fat phase is an essential element of the edible fat-containing product of the invention. Such a fat phase typically comprises edible fats and oils. There is a strong preference for non-hydrogenated fats and oils. Non-hydrogenated means that the fat or oil has not undergone any hydrogenation treatment. Preferably, the oils and fats in the fat phase contains at most 0.01 wt. % hydrogenated fat (wt. % drawn on the total fat phase), preferably no hydrogenated fat. This entails the starting ingredients as well as blends and interesterified mixtures and even fractions of fats. Non-hydrogenated fats have essentially no trans-fatty acids.

Fats and oils may be interesterified to impart desirable properties to the fat phase. Preferably enzymatic interesterification is used. The fat phase preferably comprises a sufficient amount of solid fat at low temperatures in order to yield a desired composition. Simultaneously, in order to instil desirable organoleptic properties in terms of mouthfeel and appearance, the fat phase preferably essentially melts in the mouth upon consumption. These solid fat contents are given in wt. % with respect to the fat phase.

### Solid Fat Content

The solid fat content (SFC) in this description and claims is expressed as N-value, essentially as defined in Fette, Seifen Anstrichmittel 8J) 180-186 (1978). The stabilization profile applied is heating to a temperature of 80° C., keeping the oil for at least 10 minutes at 60° C. or higher, keeping the oil for 16 hours at 0° C. and then 30 minutes at the measuring temperature, except where indicated otherwise. A suitable way to determine the solid fat content of an oil-in-water emulsion is by NMR using standard pulse methods.

### Sources of Fat and Oils

A suitable fat phase may be derived from many different fat sources. The fat phase of the edible oil-in-water or oil-in-water emulsion composition according to the present invention preferably comprises vegetable oil or vegetable fat or a combination thereof. It is preferred that the fat phase consists of vegetable oils and fats. The vegetable fats or oils may suitably be derived from coconut oil, palm oil, palm kernel oil, rapeseed oil, linseed oil, soy bean oil, maize oil, sunflower oil, or mixtures thereof. The fat phase of a product according to the invention may comprise a liquid oil fraction and a (solid) fat fraction.

### Liquid Oil Fraction

The fat phase may comprise from 0 (absent) up to 99 wt. % of liquid oil, drawn on the fat phase, preferably from 30 to 60 wt. %, more preferably from 35 to 50 wt. %. The liquid oil fraction can be an element of the fat phase of the fat-containing product of the invention.

The liquid oil fraction can be selected from the group consisting of rapeseed oil, linseed oil, soy bean oil, maize oil, sunflower oil, or mixtures thereof, preferably selected from the group consisting of rapeseed oil and sunflower oil and mixtures thereof. There are embodiments in which there is no liquid oil and wherein the fat fraction hence constitutes the fat phase.

### Fat Fraction

The fat fraction or structuring fat fraction is an element of the fat phase of the edible composition. The fat phase may comprise from 1 to 100 wt. % of fat fraction (wt. % drawn on the fat phase), preferably from 40 to 70 wt. %, more preferably from 50 to 65 wt. %. Typically, a product containing 1-3 wt % of a fat drawn on the fat phase (and the rest of the fat phase being a liquid oil) can be a liquid (pourable) composition according to the invention.

### Products

The products of the invention can be in the form of a high fat product comprising 95-99 wt. % of the fat phase (such as a wrapper) or in the form of a spread (both high fat, 60-95 wt %, and low fat, 40-80 wt % of the fat phase) with an N-line as provided herein below. Based on the N-line profile, the skilled person is capable of selecting oils and fats that meet these criteria to make an acceptable product. Suitable fat phases can be characterized by solid fat content (SFC):

| | n5 | 10 | 20 | 35 |
|---|---|---|---|---|
| High or full fat product | >50 | 35-55 | 18-35 | 0-20 |
| spread product (w/o) | 10-50 | 8-40 | 4-20 | 0-2 |
| Liquid (pourable) | | | | |
| o/w (no hardstock) | 0 | 0 | 0 | 0 |
| w/o (2% hardstock) | 1-3 | 1-3 | 1-3 | 1-3 |

In a preferred embodiment the high fat or full fat product (typically a wrapper product) has a fat phase with an N-line of N5 >50%, N10 40-55%, N20 20-30% and an N35 of <1. In a preferred embodiment the spread product, preferably as an w/o emulsion, has a fat phase with an N-line of N5 35-50%, N10 30-40%, N20 10-20% and an N35 of <1. In a low fat spread, preferably as an w/o emulsion, has a fat phase with an N-line of N5 12-40%, N10 9-30%, N20 4-20% and an N35 of <2.

The fat phase may comprise between 10 and 80% drawn on the fat phase fraction of an enzymatically interesterified fat to provide the desired solid fat content and structure.

The sugar(s) in the edible fat-containing product may be a monosaccharide and/or a disaccharide. Multiple different monosaccharides and/or disaccharides can also be present in the edible fat-containing product in combination with the fat phase, the aqueous phase and the plant-based protein.

The sugar in the edible fat-containing product may be a monosaccharide selected from the group consisting of glucose, mannose, galactose, fructose, ribose, ribulose, xylose, xylulose or a combination thereof. These monosaccharides are well known and can be safely eaten without any health risks. In addition, the listed monosaccharides are economically advantageous, and therefore suited for a fat-containing product, without increasing production costs significantly.

The sugar in the edible fat-containing product may be a disaccharide selected from the group consisting of sucrose, maltose, lactose, preferably non-dairy lactose, or a combination thereof. When lactose is derived from the milk of dairy, the resulting edible fat-containing product may not be classified as vegan anymore. Therefore, it is preferred to use non-dairy lactose, as this is appreciated by consumers and makes the product very suitable for use in a vegan diet. Sucrose, maltose and lactose are disaccharides that are relatively inexpensive and impart a browning and flavor enhancement to food similar to that of butter.

The sugar is preferably a reducing monosaccharide and/or a disaccharide, preferably selected from the group consisting of glucose, galactose, fructose, ribose, ribulose, xylose, xylulose, maltose, lactose, preferably non-dairy lactose, or a combination thereof, preferably glucose

The amount of sugar in the edible fat-containing product may be from 0.07-2 wt. %, preferably from 0.1-1 wt. %, wherein the weight percentages are based on the total weight of the product. A sugar percentage ranging from 0.07-2% by weight of the product in combination with a plant-based protein percentage ranging from 0.05-2% by weight, or from 0.08-1.6% by weight results in a sugar to plant-based protein ratio that is optimal browning of food fried, baked or broiled with the product, while formation of brown sediment is minimal or absent. Likewise, a sugar percentage ranging from 0.1-1% by weight of the product in combination with a plant-based protein percentage ranging from 0.05-2% by weight, or from 0.08-1.6% by weight also results in such an optimal ratio.

The sugar in the edible fat-containing product may be glucose. Glucose is a preferred sugar, as it was surprisingly found that it does not increase the sweetness of food, when the food is fried, baked, or boiled using the edible fat-containing product with glucose according to the invention. In contrast, when the edible fat-containing product comprises 30-98 wt. % of a fat phase, 0.01-3 wt. % of a plant-based protein and 0.05-3 wt. % of glucose, the remainder being an aqueous phase up to 100 wt. %, wherein the weight percentages are based on the total weight of the product, the product is not nearly as sweet as compared to the same product comprising 0.05-3 wt. % of fructose, maltose or sucrose instead of glucose. At the same time, the desired browning effect was very positively rated.

The plant-based protein in the edible fat-containing product may have an average molecular weight in the range of 3-500 kDa, preferably from 7-500 kDa, more preferably from 10-500 kDa. Plant-based proteins in general have a higher molecular weight as compared to animal-based proteins. The former (plant-based proteins) are suited to provide the browning effect and the flavor enhancement of foods prepared with the fat-containing product.

The plant-based protein in the edible fat-containing product may be derived from a plant selected from the group consisting of legumes, nightshades (Solanaceae), oil seeds, nuts and cereals. A plant-based protein is a protein obtained from plants, or a part thereof, such as fruits, seeds, leaves, stems, roots, flowers, etc.

The plant-based protein can be derived from a legume, wherein the legume is preferably selected from the group consisting of Broad bean (Vicia faba), Chickpea (Cicer arietinum), Lentil (Lens culinaris), Canola (B. napus subsp. napus), Potato (Solanum tuberosum) and/or almond (Prunus dulcis, syn. Prunus amygdalus). Soybeans (Glycine max) are less preferred as a basis for the plant based protein, as they may impart a bitter, undesirable taste to the edible fat-containing product. Additionally, there are some concerns on the use and origin of soybeans in view of soy being a known allergen, its ecological footprint and GM-Soy. Wheat, as a cereal, brings in additional disadvantage as containing gluten, making it a less preferred plant for a plant-based protein according to the invention. Pea is also less preferred as it has a tendency under circumstances of imparting a bean-like flavor that is less desired from a consumer's perspective. There is a higher preference for a plant-based protein, preferably plant-based isolate or -concentrate, selected from the group consisting of Broad bean (Vicia faba), Chickpea (Cicer arietinum), Lentil (Lens culinaris), and/or almond (Prunus dulcis, syn. Prunus amygdalus),

The plant-based protein can be isolated from the plant or parts of the plant. This isolate can have the form of a plant-based protein isolate or concentrate. A plant-based protein isolate or concentrate contains plant-based proteins, but can contain impurities as well, such as other plant-based components. The impurities or plant-based components present, depend on the manner of obtaining the isolate or concentrate and on the plant material itself. The plant-based protein in the edible fat-containing product according to the invention can thus be a plant-based protein isolate or concentrate. Typically, the plant-based protein isolate or concentrate contains 20-80 wt. % plant-based protein. The amount of plant-based protein in the isolate or concentrate can thus vary, depending on the plant species and the manner of isolating and/or concentrating. The plant-based protein isolate or concentrate may contain 30-80 wt. % of plant-based protein, 40-70 wt. % of plant-based protein (oil seeds), 50-80 wt. % of plant-based protein (legumes, nuts), 50-70 wt. % of plant-based protein, 20-60 wt. % of plant-based protein (cereals).

The amount of plant-based protein in the edible fat-containing product may be from 0.05-2 wt. %, and preferably from 0.08-1.6 wt. %, wherein the weight percentages are based on the total weight of the product. Thus, for a legume plant-based protein, an legume plant-based protein isolate that contains 70 wt. % of legume plant-based protein, the legume plant-based protein is present in the emulsion an amount of from 0.035 wt. % (0.05 wt. %*70 wt. %) to 1.4 wt. % (2 wt. %*70 wt. %). For other plant-based proteins and plant-based protein isolates analogous calculations are within the abilities of the average skilled person.

In preferred embodiments, the ratio of protein to sugar can be about from 0.05 to up 1 (from about 1 part protein on about 20 parts sugar to about equal parts protein and sugar), preferably from 0.1 to up to 0.75, more preferably from 0.12 up to 0.5, most preferably from 0.15 up to 0.25.

The combined amount in wt. % of protein and sugar in the product of the invention can be about 0.1-5 wt. %, preferably about 0.1-6 wt. %, more preferably about 0.2-4 wt. %, even more preferably about 0.3-3 wt. %, and most preferably about 0.4-2 wt. %.

The method for the preparation of an edible fat-containing product according to the invention comprises the steps of:
providing an aqueous component;
providing a plant protein component, preferably a plant protein isolate or -concentrate;
providing a sugar component;
providing a fat phase;
mixing the aqueous component with the plant protein component and the sugar component to provide an aqueous phase; and
mixing the fat phase with the aqueous phase to obtain the edible fat-containing product. The sugar component can also be mixed with the aqueous component and the plant protein component after mixture of the aqueous component and the plant protein component, or prior thereto. By mixing the protein component with the aqueous component prior to mixing the aqueous phase and the fat phase results in a more even distribution of the plant protein component in the aqueous phase of the edible fat-containing product.

The sugar component may comprise multiple different sugars. Depending on the supply of sugars available at a preparation facility, a combination of different sugars may be advantageous.

The sugar component may be provided as a powder or a liquid. A powder can be conveniently added and dissolves readily in the aqueous component. In addition, a powder can be easily transported to a facility for preparation of the edible fat-containing product.

On the other hand, sugar component provided as a liquid can be transported more easily within the facility using piping and pumps. A combination of sugar in the form of a powder and sugar in the form of a liquid may also be used, depending on available supplies.

A premix may be made from the aqueous component and the sugar component. This premix can be simultaneously or subsequently mixed with the plant protein component to provide an aqueous phase comprising the sugar and the protein component. It is preferred to mix the plant protein in the aqueous phase instead of in the fat phase as it was found provide more easy processing and to aid in obtaining more stable emulsions. The aqueous phase may be mixed with a fat phase to obtain the edible fat-containing product. By first mixing the aqueous component and the sugar component, the sugar component is more easily dissolved, improving the effectiveness of the method.

In general, a sugar, such as glucose, can be used in an edible fat-containing product as a browning agent in frying, baking and/or broiling. The browning effect is enhanced by inclusion of a plant-based protein in the edible fat-containing product.

The use of sugars in edible fat-containing products as a browning agent for baking is particularly surprising. Cake batter, for example, contains a lot of sucrose, usually up to one quarter of the total weight of the batter. Yet, the addition of a very small amount of plant-based protein, such as 0.01-3%, and a sugar such as glucose, such as 0.05-3%, results in a cake that has an increased brown color after baking.

the fats and oils in the fat-containing product according to the invention may be vegetable oils and fats. These fats are preferably non-hydrogenated. Vegetable oils and fats are vegan and appeal to nutrient conscious consumers. Likewise, non-hydrogenated fats are likely to contain a lower amount of trans fat as compared to hydrogenated fats. High intake of trans fats are known to have a detrimental effect on human health.

The fats and oils in the present invention are preferably selected from rapeseed oil, sunflower oil, coconut oil, palm oil, canola oil, shea butter, soybean oil, peanut oil, olive oil, corn oil, grape seed oil, nut oil, linseed oil, rice bran oil, safflower oil, sesame oil, or other plant-based oils or vegetable oils.

The fat-containing product according to the invention may contain other ingredients as well, such as emulsifiers, flavoring agents, coloring agents, salt, preservatives, etc. Emulsifiers may be selected from natural mono- and diglycerides, citric acid, lecithin, eggs, carrageenan, guar gum, mustard, preferably not synthetic esters of mono- and diglycerides, or combinations thereof. There is a preference for natural emulsifiers such as lecithin.

### EXAMPLES

The invention is illustrated by the non-limiting examples and comparative examples described below.

### Examples of Product Compositions

The composition of three fat-containing products according to the invention are given in Tables 1 and 2. In Table 2, a liquid product composition is given and the other two products in Table 1 are spreads, spread A and spread B, respectively. Variations on these product compositions were made in terms of sugar type and weight percentage, plant-based protein type and weight percentage. The variants on these compositions were used for a heating test, frying chicken, roasting potatoes, frying courgette, and baking cake.

TABLE 1
Compositions of fat-containing products: spreads.

| | 45% fat-containing | 79% fat-containing |
|---|---|---|
| | product (Spread A) | product (Spread B) |
| | g per 100 g product | g per 100 g product |
| Ingredients | (wt. %) | (wt. %) |
| Sunflower oil | 19.6 | 32.78 |
| Rapeseed oil | 16.0 | 27.0 |
| Palm oil | 9.2 | 19.0 |
| Water | 52.7 | 19.72 |
| Glucose | 0.5 | 0.5 |
| Sunflower lecithin | 0.2 | 0.2 |
| Salt | 1.3 | 0.3 |
| Fava bean protein | 0.4 | 0.4 |
| Natural flavourings | 0.10 | 0.10 |

TABLE 2
Composition of fat-containing products: liquid margarine

| | 80% liquid margarine |
|---|---|
| | g per 100 g fat/water phase (wt. %) |
| Fat phase ingredients | 80 wt. % in final product |
| Hard stock/oil blend | 99.7 |
| Soja/Sunflower lecithin | 0.3 |
| Water phase ingredients | 20 wt. % in final product |
| Carbohydrate | 0.98 (as net mono/di sugar) |
| Proteins | 0.27 |
| Salt | 7.5 |
| Water | balanced to 100 |

### Food Preparation Using a Fat-Containing Product

Chicken, potatoes, and courgettes were prepared by frying the food in a fat-containing products comprising varying amounts of fat, protein content and sugar. Browning and particle formation were subsequently assessed by comparing the fried foods to the same foods fried in butter. In addition, the browning effect of a fat-containing product according to the invention in cake was investigated.

### Materials

The ingredients used to prepare the fat-containing products are listed in Table 3, together with the supplier and country.

TABLE 3
Ingredients for preparing fat-containing products

| Ingredients | Supplier | Country |
|---|---|---|
| Fava bean protein | AGT Foods | Canada |
| isolate | | |
| Canola protein | DSM | The Netherlands |
| isolate | | |
| Almond protein | Blue Diamond Almonds | USA |
| isolate | | |
| Oat protein isolate | Tate & Lyle | The Netherlands |
| Pea/Rice protein | Kerry | Ireland |
| concentrate | | |
| Pea protein | Roquette | France |
| concentrate | | |
| Rice concentrate | Barentz | The Netherlands |
| Linseed concentrate | All Organic Treasures | Germany |
| Potato isolate | Avebe | The Netherlands |
| Sweet whey powder | Lactoland | Germany |
| Sucrose (standard | Local retailer | Local retailer |
| table sugar) | | |
| Dextrose | Holland & Barrett | The Netherlands |
| Fructose | Holland & Barrett | The Netherlands |
| Lactose | Helios Holland | The Netherlands |
| Butter | Lurpak | United Kingdom |

### Heating Test

25 g of a spread, similar to spread B, with varying protein and glucose concentrations was melted in small pan at low heat for up to 5 minutes. Assessment of the browning intensity and particles of the heated fat product was performed by at least 3 independent persons. Browning of the fat and formation of particles was assessed according to the following browning scoring scale:

1—no browning—no particles
2—golden brown—fine particles
3—brown/black—fine particles
4—brown/black—medium particles
5—brown/black—large particles
The results of the heating test are given in Table 4. It can be seen that a higher percentage of glucose, in combination with a high plant protein content, leads to a higher browning score.

### Particle Sedimentation

Sedimentation of particles is measured by transferring the (liquid) cooking or baking oil after cooking or baking with the product to a small measuring cylinder, allowing the sediment to settle for 30 minutes at ambient temperature and measuring the height of the sediment at the bottom of the cylinder using a ruler in centimetres.

### Frying Chicken:

25 g of spread, similar to spread B, with varying protein and glucose concentrations was melted in frying pan at medium heat. As soon as the fat product melted, a chicken breast was added to the pan, and fried at medium heat for 2 min, turning the chicken breast on each side every minute. The heat was then turned to low and the chicken was further fried until 6 min 30 s of total cooking time, turning the chicken on each side every minute. The chicken breast was left to rest in the pan for another 30 s, and then transferred to a plate for assessment and tasting. The juice was collected in a separate bowl. Assessment of the browning intensity and colour of the chicken and juice was performed by at least 3 independent persons, on the following 1 to 5 browning scoring scale:

1—light golden brown
2—medium golden brown
3—medium brown black
4—strong brown black
5—black

### Results of Frying Chicken

The results of the chicken frying are given in Tables 4 and 5. A plant protein concentration of 0.24 wt. % combined with 0.5-1 wt. % of glucose gives a browning score of chicken which is the same as butter. If no glucose is added, the browning score equals 2 for all tested plant protein weight percentages.

TABLE 4
Impact of varying glucose and fava bean
protein concentrations on browning

| | Plant Protein | Glucose | Browning | Browning |
|---|---|---|---|---|
| | g per 100 g | g per 100 g | score | score |
| | product (wt. %) | product (wt. %) | heating test | chicken |
| butter | n.a. | n.a. | 3 | 4 |
| 79% fat- | 0.12 | 0 | n.d. | 2 |
| containing | 0.12 | 0.5 | n.d. | 3 |
| vegan | 0.12 | 1 | n.d. | 3 |
| product | 0.24 | 0 | n.d. | 2 |
| (spread B | 0.24 | 0.5 | n.d. | 4 |
| alternatives) | 0.24 | 1 | n.d. | 4 |
| | 0.96 | 0 | 2 | n.d. |
| | 0.96 | 0.5 | 4 | n.d. |
| | 0.96 | 1 | 5 | n.d. |

### Roasting Potatoes

500 g potatoes were peeled and cut in chunks and cooked for 10 min in boiling water. 50 g of fat product was placed in an oven baking tray, and the warm potatoes were tossed into the fat-containing product, similar to spread B, in the baking tray. Potatoes were roasted in the oven at 160 C for 45 min.

Assessment of the browning intensity and colour of the roast potatoes was performed by at least 3 independent persons, on the following 1 to 3 browning scoring scale:
1—light golden brown
2—medium golden brown
3—strong golden brown

### Results of Roasting Potatoes

The results of the potato roasting are given in Table 5. It can be seen that roasting potatoes with a spread similar to spread B leads to browning results which are the same to those obtained with butter.

### Flying Courgettes

25 g of product was melted in a frying pan at medium heat. As soon as the fat-containing product, similar to spread B, had fully melted, 6 slices of courgettes of approximately 0.5 cm thickness were placed in the frying pan, and fried for 2 minutes on each side. Assessment of the browning intensity and colour of the courgettes was performed by at least 3 independent persons, on the following 1 to 3 browning scoring scale.

Roast potatoes browning scoring scale:
1—light golden brown
2—medium golden brown
3—strong golden brown

### Results of Flying Courgettes

The results of the courgette frying are given in Table 5. The fried courgettes have a brown colour which is similar to the brown colour obtained by using butter.

### Baking Cake

Batter for cakes was prepared by mixing 250 g of white caster sugar, 250 g of fat-containing product, 250 g of sieved self-rising flour, and 250 g free range eggs (4 or 5 eggs). The batter was mixed with a kitchen processor for a total of 6 minutes, increasing progressively the speed until the batter was evenly mixed. 900 g of the batter was placed into baking form (round or rectangular), and cakes were baked in an oven at 165 degrees Celsius for 60 minutes. Assessment of the browning intensity and colour of the cakes was performed by at least 3 independent persons, on the following 1 to 5 browning scoring scale

1—light golden brown
2—light to medium golden brown
3—medium golden brown
4—medium/dark golden brown
5—dark golden brown

### Results of Baking Cake

The results of the cake baking are given in Table 5. A cake baked with a spread similar to spread B has a brown color similar to the brown colour obtained by using butter. The addition of 0.5 wt. % glucose, in addition to plant protein markedly increases the browning score.

TABLE 5
Impact of combining glucose and fava bean protein on browning.

| | Browning Score | | |
|---|---|---|---|
| | | 79% fat product | 79% fat product |
| | | with 0.12% fava | with 0.12% fava |
| Food | Butter | bean, no Glucose | bean and 0.5% glucose |
| Chicken frying | 4 | 2 | 4 |
| Courgette frying | 3 | 1 | 2 |
| Potatoes roasting | 3 | 1 | 3 |
| Cake baking | 4 | 2 | 3 |

### Sugar Types

The effect of various types of sugars in the fat-containing product according to the invention was assessed. In spread A, glucose was replaced with fructose, lactose and sucrose to obtain four different spreads. The effect of these spreads on browning of fried chicken was investigated and the browning scores are given in Table 6.

Glucose, fructose, lactose and sucrose each increase the browning score of food fried with a spread similar to spread A. Glucose is however preferred as it contributes little to no sweetness to the fried, roasted, or baked food.

TABLE 6
Impact of different types of sugars on fried chicken browning.

| | Added Plant Protein | Added sugar | Browning |
|---|---|---|---|
| | (g protein per | (g protein per | score |
| | 100 g product) | 100 g product) | chicken |
| butter | n.a. | n.a. | 4 |
| 45% fat | 0% | 0% | 1 |
| containing | 0.4% | 0% | 2 |
| vegan | 0.4% | 0.5% glucose | 4 |
| product | 0.4% | 0.5% fructose | 4 |
| (spread A | 0.4% | 0.5% lactose | 4 |
| alternatives) | 0.4% | 0.5% sucrose | 4 |

### Plant-Based Protein Types

The effect of various types of plant-based proteins in the fat-containing product according to the invention was assessed. In spread B, fava bean protein was replaced with oat protein, canola protein and almond protein to obtain four different spreads, similar to spread B. The effect of these spreads on browning of fried chicken was investigated and the browning scores are given in Table 7. A comparative experiment was done with pea and carob seed protein.

Fava bean protein, oat protein, canola protein and almond protein each increase the browning score of the food fried with a spread similar to spread B. There seems to be no or very little difference in the browning scores between these different types of plant-based proteins.

TABLE 7
impact of different types of plant proteins, optionally
combined with glucose, on fried chicken browning.

| | Added Plant Protein | Added sugar | Browning |
|---|---|---|---|
| | (g protein per | (g protein per | score |
| | 100 g product) | 100 g product) | chicken |
| butter | n.a. | n.a. | 4 |
| 79% fat | 0% | 0% | 1 |
| product | 0.4% fava | 0% | 2 |
| vegan | 0.4% fava | 0.5% glucose | 4 |
| (spread B) | 0.4% oat | 0% | 2 |
| | 0.4% oat | 0.5% glucose | 4 |
| | 0.4% canola | 0% | 2 |
| | 0.4% canola | 0.5% glucose | 4 |
| | 0.4% almond | 0% | 3 |
| | 0.4% almond | 0.5% glucose | 4 |

Using a liquid margarine according to Table 2, or variants thereof with varying sugar types and concentrations, and varying plant protein types and concentrations, provided results similar to the results obtained with spreads A, spread B, and variants thereof.

### Process

A premix was formed by mixing (on a pilot scale) 0.5 kg glucose and 0.4 kg fava bean protein isolate in 52.7 kg water (for spread A), together with salt and flavour components at 60° C. A spread was prepared by subjecting the combined oil components and the lecithin to stirring and emulsification process under crystallisation conditions to yield a spread. To this end, the aqueous phase was cooled to 6 degrees Celsius and mixed with the fat phase in conventional mixing apparatus for spreads (a combination of a pin stirrer and high shear mixer. The resulting product was filled in tubs and stored at 5 degrees Celsius.

TABLE 8
Products based on spread B with different
amounts of proteins and sugars

| | | Nutritional Value and Source | |
|---|---|---|---|
| | | Protein | Carbohydrate |
| | | (g per 100 g | (g per 100 g |
| | Product | product wt. %) | product wt. %) |
| A-2 | Reference Blanco | 0 | 0 |
| | unsalted | | |
| B-2 | Butter (Lurpak | 0.6 (dairy protein) | 0.7 (lactose) |
| | unsalted) | | |
| C-2 | 79% fat- | 0.12 (Faba protein) | 0.5 (glucose) |
| D-2 | containing | 0.6 (Faba protein) | 0.7 (glucose) |
| E-2 | vegan | 0.6 (Faba protein) | 0.7 (lactose) |
| F-2 | product | 0.12 (Faba protein) | 0.7 (lactose) |
| G-2 | (Spread B) | 0.12 (dairy protein) | 0.5 (lactose) |
| P1-2 | | 0.12 (Faba protein) | 0 (glucose) |
| P2-2 | | 0.12 (Faba protein) | 0.5 (glucose) |
| P3-2 | | 0.12 (Carob protein) | 0 (glucose) |
| P4-2 | | 0.12 (Carob protein) | 0.5 (glucose) |
| Ca1 | | 0.12 (Canola protein) | 0 (glucose) |
| Ca2 | | 0.12 (Canola protein) | 0.5 (glucose) |
| Ca3 | | 0.6 (Canola protein) | 0.7 (glucose) |
| H2 | | 1.5 (Faba protein) | 0.5 (glucose) |
| H6 | | 0.12 (Faba protein) | 1.5 (glucose) |
| H9 | | 1.5 (Faba protein) | 1.5 (glucose) |
| H10 | | 3 (Faba protein) | 3 (glucose) |
| H11 | | 5 (Faba protein) | 5 (glucose) |

### Experiment 1: Comparison of Plant Proteins with Animal Proteins

### Heating Test

The products were subjected to heat testing as described herein elsewhere. The results are in table 9:

TABLE 9
Heat testing products with varying proteins and sugars.

| | | Protein | Carbohydrate | | | | |
|---|---|---|---|---|---|---|---|
| | | (g Per | (g per g | | | Height | Visual |
| | | 100 g | 100 | Ratio | Protein + | of the | Browning |
| | | product | product) | protein/ | Carbohydrate | Residue, | Score (1- |
| Product | Sample | wt. %) | wt. % | sugar | (wt %) | cm | 5) |
| Reference | A-2 | 0 | 0 | | 0 | 0.1 | 1 |
| Blanco | | | | | | | |
| unsalted | | | | | | | |
| Butter | B-2 | 0.6 | 0.7 (lactose) | 0.85 | 1.3 | 0.8 | 3 |
| (Lurpak | | (dairy) | | | | | |
| unsalted) | | | | | | | |
| 79% fat- | C-2 | 0.12 | 0.5 (glucose) | 0.24 | 0.62 | 0.4 | 2 |
| containing | | (faba) | | | | | |
| vegan | D-2 | 0.6 | 0.7 (glucose) | 0.85 | 1.3 | 0.1 | 2 |
| product | | (faba) | | | | | |
| (Spread B) | E-2 | 0.6 | 0.7 (lactose) | 0.85 | 1.3 | 0.5 | 2 |
| | | (faba) | | | | | |
| | F-2 | 0.12 | 0.7 (lactose) | 0.17 | 0.82 | 0.2 | 2 |
| | | (faba) | | | | | |
| | G-2 | 0.12 | 0.5 (lactose) | 0.24 | 0.62 | 0.8 | 3 |
| | | (dairy) | | | | | |

The result of plant proteins compared to butter proteins is that higher browning scores are obtained using lower amounts of plant proteins and in absence of burned residues. Glucose provides a better browning and less residue compared to lactose. A ratio of protein to sugar of about 0.25 gives a good result.

### Cooking Test: Fried Potatoes

Potatoes were fried as described herein above. The results are in table 10.

TABLE 10
Frying potatoes using various proteins and sugars.

| | | Protein | Carbohydrate | | | | Visual |
|---|---|---|---|---|---|---|---|
| | | (g Per | (g per | | Protein + | Visual | Browning |
| | | 100 g | 100 g | Ratio | Carbo- | Browning | brown |
| | | product | product | protein/ | hydrate | Score | spots |
| Product | Sample | wt. %) | wt. %) | sugar | (wt. %) | 1-5 | Score 1-5 |
| Reference | A-2 | 0 | 0 | | 0 | 1 | 0 |
| Blanco | | | | | | | |
| unsalted | | | | | | | |
| Butter | B-2 | 0.6 | 0.7 (lactose) | 0.85 | 1.3 | 3 | 3 |
| (Lurpak | | | | | | | |
| unsalted) | | (dairy) | | | | | |
| 79% fat- | C-2 | 0.12 | 0.5 (glucose) | 0.24 | 0.62 | 3 | 1 |
| containing | | (faba) | | | | | |
| vegan | D-2 | 0.6 | 0.7 (glucose) | 0.85 | 1.3 | 3 | 3 |
| product | | (faba) | | | | | |
| (Spread | E-2 | 0.6 | 0.7 (lactose) | 0.85 | 1.3 | 4 | 3 |
| B) | | (faba) | | | | | |
| | F-2 | 0.12 | 0.7 (lactose) | 0.17 | 0.82 | 3 | 3 |
| | | (faba) | | | | | |
| | G-2 | 0.12 | 0.5 (lactose) | 0.24 | 0.62 | 3 | 4 |
| | | (dairy) | | | | | |

Plant proteins give higher browning scores of fried potatoes than animal proteins at the same level of proteins and sugar. Glucose gives less black spots than lactose. Lower level of proteins also giver less black spots, resulting in a more attractive product (more homogenous and comparable browning).

### Cooking Test: Fried Chicken

Chicken was fried as described herein above. The results are in table 11.

TABLE 11
Frying chicken using various proteins and sugars.

| | | Protein | Carbohydrate | | | | Visual |
|---|---|---|---|---|---|---|---|
| | | (g Per | (g per | | Protein + | | Browning- |
| | | 100 g | 100 g | Ratio | Carbo- | Visual | brown |
| | | product | product | protein/ | hydrate | Browning | spots |
| Product | Sample | wt. %) | wt. %) | sugar | (wt %) | Score 1-5 | Score 1-5 |
| Reference | A-2 | 0 | 0 | | 0 | 1 | 0 |
| Blanco | | | | | | | |
| unsalted | | | | | | | |
| Butter | B-2 | 0.6 | 0.7 (lactose) | 0.85 | 1.3 | 3 | black spots |
| (Lurpak | | (animal) | | | | | |
| unsalted) | | | | | | | |
| 79% fat- | C-2 | 0.12 | 0.5 (glucose) | 0.24 | 0.62 | 3 | reddish |
| containing | | (faba) | | | | | |
| vegan | D-2 | 0.6 | 0.7 (glucose) | 0.85 | 1.3 | 4 | black spots |
| product | | (faba) | | | | | |
| (Spread B) | E-2 | 0.6 | 0.7 (lactose) | 0.85 | 1.3 | 4 | reddish |
| | | (faba) | | | | | |
| | F-2 | 0.12 | 0.7 (lactose) | 0.17 | 0.82 | 4 | reddish |
| | | (faba) | | | | | |
| | G-2 | 0.12 | 0.5 (lactose) | 0.24 | 0.62 | 3 | reddish |
| | | (animal) | | | | | |

The use of plant proteins allows for more homogenous browning at lower amounts. Higher protein levels increased black spots and inhomogeneous browning. A chicken fried with a product containing 0.12% plant protein and 0.5% glucose (C2) was found to be tastier and juicier with a tasting panel. The use of lactose gave a more reddish colour.

### Experiment 2: Comparative Experiments with Carob and Canola Protein

Products were formulated analogous to spread B (79% fat containing vegan product). Carob and faba protein powder were reconstituted 1:1 with water and a clear colour and texture difference was found. Faba bean protein powder is gum and has beige color; carob protein powder becomes like a dough and has dark brown color.

### Heating Test

The products were subjected to heat testing as described herein elsewhere. The results are in table 12:

TABLE 12
Heat testing products with Carob and canola proteins.

| | | | Carbo- | | | |
|---|---|---|---|---|---|---|
| | | Protein | hydrate | | | |
| | | (g Per | (g per | Protein + | Height | Visual |
| | | 100 g | 100 g | Carbo- | of the | Browning |
| | | product | product | hydrate | Residue, | Score |
| Product | Sample | wt. %) | wt. %) | (wt %) | (cm) | (1-5) |
| 79% fat- | P1-2 | 0.12 | 0 | 0.12 | 0 | 1 |
| containing | | (faba) | (glucose) | | | |
| vegan | P2-2 | 0.6 | 0.5 | 1.1 | 0.4 | 2 |
| product | | (faba) | (glucose) | | | |
| (Spread B) | C-2 | 0.12 | 0.5 | 0.62 | 0.4 | 2 |
| | | (faba) | (glucose) | | | |
| | D-2 | 0.6 | 0.7 | 1.3 | 0.1 | 2 |
| | | (faba) | (glucose) | | | |
| | P3-2 | 0.12 | 0 | 0.12 | 0.15 | 1 |
| | | (carob) | (glucose) | | | |
| | P4-2 | 0.12 | 0.5 | 0.62 | 0.2 | 2 |
| | | (carob) | (glucose) | | | |
| | Ca1 | 0.12 | 0 | 0.12 | 0 | 1 |
| | | (canola) | (glucose) | | | |
| | Ca2 | 0.12 | 0.5 | 0.62 | 0.1 | 2 |
| | | (canola) | (glucose) | | | |
| | Ca3 | 0.6 | 0.7 | 1.3 | 0.2 | 2 |
| | | (canola) | (glucose) | | | |

Carob-containing products express a stronger stickiness to the pan. Faba protein provides a more intense browning (C-2>Ca3>P4-2) at a lower protein content.

### Cooking Test: Fried Potatoes

Potatoes were fried as described herein above. The results of the heating test are in table 13.

TABLE 13
Frying potatoes using carob and canola proteins.

| | | | | | Visual |
|---|---|---|---|---|---|
| | | Protein | Carbohydrate | Protein + | Browning |
| | | (g per 100 g | (g per 100 g | Carbohydrate | Score |
| Product | Sample | product wt. %) | product wt. %) | (wt %) | (1-5) |
| 79% fat- | P1-2 | 0.12 (faba) | 0 (glucose) | 0.12 | 1 |
| containing | P2-2 | 0.6 (faba) | 0.5 (glucose) | 1.1 | 3 |
| vegan | C-2 | 0.12 (faba) | 0.5 (glucose) | 0.62 | 3 |
| product | D-2 | 0.6 (faba) | 0.7 (glucose) | 1.3 | 3 |
| (spread B) | P3-2 | 0.12 (carob) | 0 (glucose) | 0.12 | 1 |
| | P4-2 | 0.12 (carob) | 0.5 (glucose) | 0.62 | 3 |
| | Ca1 | 0.12 (canola) | 0 (glucose) | 0.12 | 1 |
| | Ca2 | 0.12 (canola) | 0.5 (glucose) | 0.62 | 3 |
| | Ca3 | 0.6 (canola) | 0.7 (glucose) | 1.3 | 4 |

Products that contains faba protein gave significantly higher browning to potatoes, regardless of the amount of sugar addition. The browning in potatoes is also more homogenous when fried with products that contains faba bean protein than with carob. All evaluators recorded taste of potato fried with product that contains 0.6% carob and 0.5% glucose as slippery in the mouth and an unpleasant mouthfeel. Samples with faba bean protein gave more richness in taste and improved texture. Form and amount of dark particles on the potato surface and in the residue are different in spread samples containing faba and canola with 0.6% protein and 0.7% sugar. Faba containing sample has finer particles, canola containing sample has several very big black burnt particles. In this set evaluators who tasted the potatoes did not remark on slippery mouthfeel.

### Cooking Test: Fried Chicken

Chicken was fried as described herein above. The results are in table 14.

TABLE 14
Frying chicken using carob and canola proteins.

| | | | | | Visual |
|---|---|---|---|---|---|
| | | Protein | Carbohydrate | Protein + | browning |
| | | (g per 100 g | (g per 100 g | Carbohydrate | score |
| Product | Sample | product wt. %) | product wt. %) | (wt %) | (1-5) |
| 79% fat- | P1-2 | 0.12 (faba) | 0 (glucose) | 0.12 | 1 |
| containing | P2-2 | 0.6 (faba) | 0.5 (glucose) | 1.1 | 3 |
| vegan | C-2 | 0.12 (faba) | 0.5 (glucose) | 0.62 | 3 |
| product | D-2 | 0.6 (faba) | 0.7 (glucose) | 1.3 | 4 |
| (Spread B) | P3-2 | 0.12 (carob) | 0 (glucose) | 0.12 | 2 |
| | P4-2 | 0.12 (carob) | 0.5 (glucose) | 0.62 | 3 |
| | Ca1 | 0.12 (canola) | 0 (glucose) | 0.12 | 1 |
| | Ca2 | 0.12 (canola) | 0.5 (glucose) | 0.62 | 3 |
| | Ca3 | 0.6 (canola) | 0.7 (glucose) | 1.3 | 4 |

Chicken fried with product that contains carob protein results in having big particles on top of its surface, regardless of sugar level, which causes inhomogeneous browning. Chicken fried with product that contains faba protein showed homogeneous browning without any particles on its surface. All evaluators recorded the taste of chicken fried with product that contains 0.6% carob and 0.5% glucose as unpleasantly sweet, and strong caramelic. Increasing the level of sugar gives an increase in browning at chicken surface for all samples containing Faba, Canola and Carob protein. If the color of the chicken is compared which was fried with product containing 0.12% protein and 0.5% sugar, then increase in browning is higher for P3-2 (carob) and C-2 (faba) than in Ca2 (canola). In case of 0.6% protein and 0.7% sugar, D-2 (faba) expresses more intense browning than Ca3 (canola).

### Experiment 3: Varying Protein and Sugar Levels

### Heating Test

The products were subjected to heat testing as described herein elsewhere. The results are in table 15:

TABLE 15
Heat testing products with varying amounts of proteins and sugars.

| | | Protein | Carbo- | | | | |
|---|---|---|---|---|---|---|---|
| | | (g Per | hydrate | | Protein + | Height | |
| | | 100 g | (g per 100 g | Ratio | Carbo- | of the | Visual |
| | | product | product | protein/ | hydrate | Residue, | browning |
| Product | Sample | wt. %) | wt. %) | sugar | (wt %) | cm | score (1-5) |
| 79% fat- | C-2 | 0.12 | 0.5 | 0.24 | 0.62 | 0.4 | 2 |
| containing | | (faba) | (glucose) | | | | |
| vegan | D-2 | 0.6 | 0.7 | 0.85 | 1.3 | 0.1 | 2 |
| product | | (faba) | (glucose) | | | | |
| (spread | H2 | 1.5 | 0.5 | 3 | 2 | 1.2 | 3 |
| B) | | (faba) | (glucose) | | | | |
| | H6 | 0.12 | 1.5 | 0.08 | 1.62 | 0.5 | 2 |
| | | (faba) | (glucose) | | | | |
| | H9 | 1.5 | 1.5 | 1 | 3 | 1.8 | 4 |
| | | (faba) | (glucose) | | | | |
| | H10 | 3 | 3 | 1 | 6 | 2.1 | 4 |
| | | (faba) | (glucose) | | | | |
| | H11 | 5 | 5 | 1 | 10 | 2.4 | 5 |
| | | (faba) | (glucose) | | | | |

Visual observation shows that there is clear increase in browning when protein and sugar level increases with same composition level.

Increased browning intensity is observed in the samples: H11>H10>H9>H2>C-2, respectively.

### Cooking Test: Fried Potatoes

Potatoes were fried as described herein above. The results of the test are in table 16.

TABLE 16
Frying potatoes using various amounts of proteins and sugars.

| | | | | | Visual |
|---|---|---|---|---|---|
| | | Protein | Carbohydrate | Protein + | browning |
| | | (g per 100 g | (g per 100 g | Carbohydrate | score |
| Product | Sample | product wt. %) | product wt. %) | (wt %) | (1-5) |
| 79% fat- | C-2 | 0.12 (faba) | 0.5 (glucose) | 0.62 | 3 |
| containing | D-2 | 0.6 (faba) | 0.7 (glucose) | 1.3 | 3 |
| vegan | H2 | 1.5 (faba) | 0.5 (glucose) | 2.0 | 3 |
| product | H6 | 0.12 (faba) | 1.5 (glucose) | 1.62 | 4 |
| (spread B) | H9 | 1.5 (faba) | 1.5 (glucose) | 3.0 | 5 |
| | H10 | 3 (faba) | 3 (glucose) | 6 | 5 |
| | H11 | 5 (faba) | 5 (glucose) | 10 | 2 |

Visual observation shows that high protein concentration together with high glucose increases the residue and black particle formation which reveals inhomogeneous browning. Inhomogeneity is also seen when only using high protein concentration on the product (H2). On the contrary, only using high sugar concentration results in homogenous browning (H6).

The present invention thus provides a vegan fat-containing product wherein plant proteins in combination with sugars provide good browning effects. The plant proteins, especially faba protein can be used in lower amounts compared to dairy proteins for similar browning effects and can provide more homogenous browning in combination with less and smaller dark particles, especially compared to carob and canola proteins. Increased amount of sugar ad protein combined increase browning, but also increase particle formation (residue)

1. An edible fat-containing product which is
a water-in-oil emulsion comprising 40-95 wt. % of a fat phase or
a full fat product comprising 95-99 wt. % of the fat phase,
the remainder being an aqueous phase up to 100 wt. %, wherein the product further comprises
0.01-3 wt. % of a plant-based protein, wherein the plant-based protein is Broad bean (Vicia faba) protein, and
0.05-3 wt. % of glucose, preferably 0.05-1.6 wt. % of glucose,
wherein the weight percentages are based on the total weight of the product.

2. The edible fat-containing product according to claim 1, wherein the plant-based protein and/or the glucose are dispersed in the aqueous phase.

3. The edible fat-containing product according to claim 1, wherein the edible fat-containing product comprises a natural emulsifier.

4. The edible fat-containing product according to claim 3, wherein the natural emulsifier is lecithin.

5. The edible fat-containing product according to claim 1, wherein all or at least a part of the fat phase is enzymatically interesterified.

6. The edible fat-containing product according to claim 1, wherein the amount of plant based protein is from 0.05 2 wt. %, wherein the weight percentages are based on the total weight of the product.

7. The edible fat-containing product according to claim 1, wherein the amount of glucose is from 0.07 2 wt. %, wherein the weight percentages are based on the total weight of the product.

8. The edible fat-containing product according to claim 1, wherein a combined amount in wt. % of protein and glucose in the product of the invention is from 0.1 up to 5 wt. %.

9. A method for the preparation of an edible fat-containing product according to claim 1, comprising the steps of:
providing an aqueous component;
providing a plant protein component, wherein the plant protein is Broad bean (Vicia faba) protein;
providing a glucose component;
providing a fat phase;
mixing the aqueous component with the plant protein component and the glucose component to provide an aqueous phase; and
mixing the fat phase with the aqueous phase to obtain the edible fat-containing product.

10. The method according to claim 9, wherein the glucose component is provided as a powder or a liquid.

11. A method of using an edible fat-containing product, comprising:
preparing a mixture comprising the edible fat-containing product of claim 1 and one or more additional components; and
frying, baking and/or broiling the mixture.

12. The method of claim 1, wherein the edible fat-containing product further comprises a plant protein component, preferably a plant protein isolate or -concentrate, wherein the plant protein is Broad bean (Vicia faba) protein.

13. The edible fat-containing product according to claim 1, wherein the plant-based protein is a plant-based isolate or concentrate.

14. The edible fat-containing product according to claim 6, wherein the amount of plant based protein is from 0.08-1.6 wt. %.

15. The edible fat-containing product according to claim 7, wherein the amount of glucose is from 0.1-1 wt. %.

16. The method of claim 9, wherein the plant component is a plant protein isolate or concentrate.
